(19) United States
(12) Patent Application Publication
(10) Pub. No.: US 2009/0218220 A1
(43) Pub. Date: Sep. 3, 2009

(54) Amperometric Electrochemical Cells and Sensors

(75) Inventors: Paul J. Matter, Columbus, OH (US); Matthew M. Seabaugh, Columbus, OH (US); Lora B. Thrun, Grove City, OH (US); Scott L. Swartz, Columbus, OH (US); Michael J. Day, Dublin, OH (US); William J. Dawason, Dublin, OH (US); Buddy E. McCormick, Dublin, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(73) Assignee: NexTech Materials Ltd.

(21) Appl. No.: 12/395,998

(22) Filed: Mar. 2, 2009

Related U.S. Application Data
(60) Provisional application No. 61/067,464, filed on Feb. 28, 2008.
(60) Provisional application No. 61/147,341, filed on Jan. 26, 2009.

(51) Int. Cl. G01N 27/26

(52) U.S. Cl. 204/424

(57) ABSTRACT

Amperometric ceramic electrochemical cells comprise, in one embodiment, an electrolyte layer, a sensing electrode layer, and a counter electrode layer, wherein the cell is operable in an oxidizing atmosphere and under an applied bias to exhibit enhanced reduction of oxygen molecules at the sensing electrode in the presence of one or more target gases such as nitrogen oxides (NO_{X}) or NH₃ and a resulting increase in oxygen ion flux through the cell. In another embodiment, amperometric ceramic electrochemical cells comprise an electrolyte layer comprising a continuous network of a first material which is ionically conducting at an operating temperature of about 200 to 550° C.; a counter electrode layer comprising a continuous network of a second material which is electrically conductive at an operating temperature of about 200 to 550° C.; and a sensing electrode layer comprising a continuous network of a third material which is electrically conductive at an operating temperature of about 200 to 550° C., which sensing electrode is operable to exhibit increased charge transfer in the presence of one or more target gas species. These electrochemical cells and additional electrochemical cell embodiments are suitable for use in gas sensors and methods of sensing or detecting one or more target gases.

### CROSS-REFERENCE TO RELATED APPLICATIONS

The present application claims priority under 35 U.S.C. §119 to U.S. Application Ser. Nos. 61/067,464 filed Feb. 28, 2008 and 61/147,341 filed Jan. 26, 2009.

### FIELD OF THE INVENTION

This invention relates to amperometric ceramic electrochemical cells and sensors which, in specific embodiments, are suitable for detecting one or more target gas species, for example, nitrous oxides (NO_{X}) and/or ammonia, in a gaseous atmosphere such as in hydrocarbon combustion products, and to materials that enable functionality of these devices. In a specific embodiment, the cells and sensors of the invention may be used for NO_{X} and/or NH₃ emissions detection in diesel fueled vehicles.

### BACKGROUND OF THE INVENTION

The increase in worldwide industrialization has generated concern regarding pollution created by combustion processes. Particularly, emissions from vehicles or other distributed sources are of concern. New environmental regulations are driving NO_{X} (a mixture of NO and NO₂ of varying ratio) emissions from diesel fueled vehicles to increasingly lower levels, with the most challenging of these being the 2010 EPA Tier 2 diesel tailpipe standards. To meet these, engine manufacturers have been developing new diesel after-treatment technologies including selective catalyst reduction (SCR) systems and lean NO_{X} traps (LNT). See for example: T. Johnson, 2008 SAE International Proceedings, 2008-01-0069 (2008). These systems require multiple NO_{X} sensors to monitor performance and satisfy on-board diagnostics requirements for tailpipe emissions. Point of generation abatement technologies have been developed for NO_{X}, among other pollutants, but these solutions can reduce fuel efficiency if they are applied without closed loop control. Further, some of the proposed solutions can be polluting (e.g. selective catalytic reduction systems for NO_{X} can release ammonia into the atmosphere) if improperly controlled. Control of these abatement technologies requires the development of compact, sensitive sensors for NO_{X} and other pollutants in oxygen-containing (lean-burn) exhaust streams.

Sensors that have been proposed to date cannot meet the requirements of the applications. The great majority of NO_{X} detectors rely on the potentiometric or amperometric measurement of oxygen partial pressure (from the decomposition of NO₂ molecules to NO and NO to N₂ and O₂) to determine NO_{X} concentration. This requires that the device be constructed with reference electrodes or reference pumping circuits to separate the NO_{X} concentration from the background oxygen concentration.

Electrochemical sensors offer a means of measuring gas constituents in an analyte stream using a small, low power device. A number of electrochemical sensor approaches have been reported in the past. See for examples: J. W. Fergus, Sensors and Actuators B121, 652-663 (2007); W. Gopel, et al., Solid State Ionics 136-137, 519-531 (2000); and S. Zhuiykov, et al., Sensors and Actuators B 121, 639-651 (2007). These approaches range from potentiometric mixed potential sensors to impedance-based sensors to amperometric sensors. Most of these approaches employ a ceramic electrolyte material as one component of the device, with electrode materials that provide sensitivity to a gas species of interest. A broad scope of materials have been evaluated as the sensing and reference electrodes in these designs, including precious and base metals, as well as cermets, and both simple and complex oxides. The electrolyte selection has been much narrower, focusing principally on yttrium-stabilized zirconia and a minority of examples of NASICON electrolytes. None of these approaches meets all of the key requirements of the diesel exhaust application.

Mixed potential designs rely on the different kinetics of reaction to occur at the sensing and reference electrodes. For the example of NO_{X} detection, two reactions are of interest:

the reduction of NO₂ to NO: (1) NO₂→½O₂+NO; and/or

the reverse reaction of oxidation of NO to NO₂: (2) NO+½O₂→NO₂.

These reactions occur at different rates over different electrode materials. The local liberation or consumption of molecular oxygen changes the oxygen partial pressure at the sensing electrode, and results in a change in the electromotive force (EMF) generated in contrast to the reference electrode. Reference electrodes are selected to be inert to these reactions but active for O₂ reduction (such as Au or Pt). Examples of sensing electrodes for mixed potential sensors include simple oxides such as WO₃, NiO, ZnO, Cr₂O₃, V₂O₅ or mixed oxides such as spinels composed of di- and trivalent transition metals, or lanthanide ferrite or chromite-based perovskites. Because the reference electrode compensates for oxygen that may be present in the gas stream, the EMF between the sensing and reference electrodes can be correlated directly with the concentration of NO or NO₂ present.

Drawbacks to the mixed potential approach include the interference of other gas species with the sensing and reference electrodes. Reducing gases present in the gas stream, such as hydrocarbons and CO, will interfere with the signal. Another complexity of mixed potential devices is that the catalytic reaction between NO and the sensing electrode consumes oxygen, resulting in a negative relative EMF, while the reduction of NO₂ generates a positive EMF through the liberation of O₂ causing inaccurate measurement of total NO_{X} concentration.

A number of strategies have been proposed to overcome these limitations. Protective zeolite coatings have been used, which allow gas molecules of only a particular size to pass through to the sensing element, barring the combustion products, hydrocarbons and particulates from affecting the measurement. Alternatively, selective sensing electrode materials may be employed which favor only the oxidation or reduction reaction (such as LaCoO₃, which has been identified to be responsive to NO₂ but not NO) allowing arrays of mixed potential sensors to be used to determine the NO and NO₂ concentration. Similarly, a non-selective sensing electrode can be biased at different voltages to produce an array of sensors which can be simultaneously solved to determine NO and NO₂ concentration.

A fundamental concern in the development of mixed potential sensors is that the sensing electrode microstructure controls the non-equilibrium oxygen partial pressure and the kinetics that generate the mixed-potential response. It has also been suggested that microstructure control through the development of multi-component nanocomposite electrodes may allow development of sufficiently responsive and stable electrode materials, but at this time, such devices have not been demonstrated.

Amperometric designs measure the current resulting from a constant applied voltage on an electrochemical cell. A number of amperometric sensor designs have been reported in the literature. Electrolytes of these designs are limited to NASICON, YSZ, and lanthanum gallate electrolytes, operating at temperatures ranging from below 200° C. for NASICON to above 500° C. for the YSZ and lanthanum gallate electrolytes.

Amperometric designs as reported in the literature have commercial viability, as will be discussed below. However, they must overcome the limited current that can be achieved by conventional approaches. The devices disclosed in the literature rely upon the catalytic decomposition of NO_{X} to provide the detected current under the imposed voltage, as shown by the following equations:

the reduction of NO₂ to NO: (3) NO₂→+½O₂+NO, and/or

the reduction of NO to N₂ and O₂: (4) NO→½N₂+½O₂.

Due to the very low concentrations of NO_{X} anticipated in the applications, the signals achieved by these devices are extremely low, limiting the resolution, accuracy, and detection threshold of these sensors. For tailpipe emissions monitoring of NO_{X} in diesel vehicles, accurate detection of low ppm concentrations of NO_{X} is essential to meeting emissions regulations. Additionally, these low signals require additional shielding to protect from electromagnetic interference.

Impedance-based sensors are the third class of electrochemical devices that have been proposed for NOx sensing applications. In these devices, an oscillating voltage is applied to the sensing electrodes, and the current generated by the voltage is measured. By tailoring the frequency of the voltage oscillations, the response can be selected to correlate with specific non-ohmic contributions to the device resistance. In this approach, the divergent responses of NO and NO₂ in mixed potential mode are not observed; instead, signals of the same sign and magnitude are observed. However, these devices are the earliest in development and experience interference from both CO₂ and H₂O, which will always be present in exhaust streams. Finally, even under simplified operating conditions, impedance-based sensors will require more complex signal processing than mixed potential or amperometric sensors.

Several of the above sensor design approaches have been described in the technical and patent literature. One such device is a multi-chamber potentiometric device, which uses a multi-stage reaction approach to condition the exhaust stream for NO_{X} detection. See for examples: U.S. Pat. No. 5,861,092; U.S. Pat. No. 5,897,759; U.S. Pat. No. 6,126,902; U.S. Pat. No. 6,143,165; U.S. Pat. No. 6,274,016; and U.S. Pat. No. 6,303,011. In an initial reaction chamber, oxygen from an external air stream is pumped into the measurement chamber to oxidize all residual hydrocarbons and carbon monoxide, and convert the NO to NO₂. The resultant test stream is then exposed to a mixed potential sensing and reference electrode set. The resulting potential is measured to determine NO_{X} concentration. Given the delay for the required processing of the sample gas, the response time of the sensor is anticipated to be too long (several seconds) for use in vehicle applications.

A second mixed potential sensor using yttria-stabilized zirconia (YSZ) with a zeolite-modified electrode, has been studied for NO_{X} detection. See for examples: U.S. Pat. No. 6,764,591; U.S. Pat. No. 6,843,900; and U.S. Pat. No. 7,217,355. This device only works well at high temperatures, is very sensitive to changes in temperature, and has response times of two seconds or more. Due to the slow response times, this technology has not been employed for mobile applications.

The most prominent sensor type for detecting NO_{X} is an amperometric device relying upon multiple oxygen ion pumps, developed and patented by NGK Insulators in Japan. See for example: U.S. Pat. No. 4,770,760 and U.S. Pat. No. 5,763,763. In this technology, considered by engine manufacturers to be the principal viable commercial NO_{X} sensor, all the molecular oxygen in the exhaust gas stream is electrochemically pumped from the exhaust gas sample, before the remaining NO_{X} can be reduced to N₂ and O₂ by a catalytic electrode material (typically a Pt/Rh alloy) and the resulting oxygen ionic current measured. These sensors are relatively slow, complex, costly, and cannot sense the low NO_{X} concentrations needed by the diesel engine industry. Additionally, they exhibit a strong cross-sensitivity to ammonia, causing erroneous NO_{X} measurements in ammonia-containing gas environments. To effectively monitor NO_{X} breakthrough in either selective catalytic reduction or lean NO_{X} trap systems, resolution of at least 5 ppm and preferably 3 ppm is needed compared to the 10 ppm accuracy of the NGK sensor.

In other research (see for example G. Reinhardt, et al., Ionics 1, 32-39 (1995)), NO is reported to assist in the electrochemical reduction of oxygen, forming the basis of an amperometric sensor. Because of the electrode and electrolyte materials used, however, the demonstrated cell required a minimum operating temperature of 600° C. At these higher temperatures, O₂ and CO₂ adsorption are thermodynamically favored over NO_{X} adsorption. See: P. Broqvist, et al., Journal of Physical Chemistry B, 109:9613-9621 (2005). Consequently, Reinhardt and his co-workers did not demonstrate NO_{X} sensitivity in the presence of CO₂ or water or at low NO_{X} concentrations, and only demonstrated detection of NO_{X} at high temperatures in simplified gas atmospheres. For operation in diesel engine exhaust systems, the ability to detect ppm levels of NO_{X} in the presence of CO₂ and H₂O is essential, making this approach impractical for use in these applications.

Accordingly, a need exists for improved sensors for accurately detecting NO_{X} or other target gas species.

### SUMMARY OF THE INVENTION

The electrochemical cells and sensors of the present invention, and methods employing the same, overcome various limitations of the above-described approaches. This invention is directed to electrochemical cells and sensors for, inter alia, detecting engine emissions in the oxygen-containing environment of a combusted hydrocarbon fuel exhaust, using an electro-catalytic effect. The electrochemical cells and sensors of the invention can operate in combustion exhaust streams with significantly enhanced sensitivity to both NO_{X} and ammonia (NH₃), with less dependence on oxygen partial pressure, with a faster response, and at lower temperatures than various sensors of the prior art.

The electrochemical cells and sensors of the invention are distinguishable from various known sensors due to the mechanism employed to detect gas constituents and the temperature at which the electrochemical cells and sensors operate. The electrochemical cells and sensors are configured as amperometric devices but respond when adsorbed gas species increase the rate of oxygen reduction on the sensing electrode of the devices. The electrochemical cells and sensors do not require catalytic NO_{X} decomposition to sense the NO_{X} concentration and, rather, use an increase in oxygen reduction current, caused by the presence of adsorbed NO_{X}, to detect NO_{X} in an oxygen-containing gas stream. This mechanism is extremely fast compared to various competing sensor technologies and produces a current greater than what is possible from the reduction of NO_{X} alone. Further, this catalytic approach has been demonstrated to extend to other gaseous species, including NH₃.

The amperometric cells and sensors are based on an oxygen ion conducting cell, but unlike conventional sensors, this approach does not rely on the oxygen ion current resulting from the direct decomposition of NO_{X} in the gas stream as the response signal. In specific embodiments, Perovskite electrodes, such as (La_{1-X}Sr_{X})(Co_{1-Y}Fe_{Y})O_{3-δ} (LSCF), where X ranges from approximately 0.2 to 0.4 and Y ranges from approximately 0.2 to 0.4, when applied to an oxygen ion (O₂—) conducting electrolyte show catalytic activity for O₂ reduction in the presence of NO_{X} and/or NH₃. In this novel approach, the cells and sensors detect NO_{X} and NH₃ through a catalytic effect, in which the reduction of oxygen in the gas stream is catalyzed by the presence of NO_{X} and NH₃ species on the surface of such an electrode. This results in a device with particular advantages in design simplicity and flexibility, materials selection, and operating conditions in contrast to previously disclosed sensors. The cells and sensors also are responsive to NO_{X} in the presence of steam, carbon dioxide and sulfur oxides (SO_{X}). The cells and sensors have a tunable response to NH₃, which allows only NO_{X} to be detected or both NO_{X} and NH₃ to be detected and quantified at the same time. Specific sensor embodiments have been demonstrated to detect NO and NO₂ at levels as low as 3 ppm and/or to exhibit sensor response as fast as 50 ms, allowing for better system controls or even engine feedback control. Further, in certain embodiments, the disclosed cells and sensors operate in a temperature range of 200 to 550° C., over which the NO_{X} and NH₃ responses are significantly greater than the sensitivity to variable background exhaust gases.

While the cells and sensors of the present invention have applicability to detection of NO_{X} in heavy duty diesel exhaust systems, the same may be useful in a wide range of other applications in which rapid response to low levels of NO_{X} is desired. The NO_{X} cells and sensors are particularly useful in sensing low levels of NO_{X} in the presence of fixed or variable concentrations of other gases, including without limitation O₂, CO₂, Sox (SO and/or SO₂), H₂O, and NH₃. Further, the cells and sensors formulation, operating temperature, and applied voltage can be tuned to be responsive to other gases that alter oxygen reduction activity of the sensing electrode, including without limitation SO_{X}, O₂, NH₃, and CO₂. Cells and sensors tailored to the detection of low levels of these gases also may be useful in a wide range of applications.

Various embodiments, features and advantages of the invention will be more fully understood in view of the following detailed description.

### BRIEF DESCRIPTION OF THE DRAWINGS

Sensors of the present invention are described with reference to several figures, in which:

FIG. 1 is a photograph of the sensor design of Example 1 showing: (a): gadolinium doped ceria ceramic electrolyte membrane disc, without electrodes; and (b) ceramic electrolyte disc with (La_{0.6}Sr_{0.4}) (Cu_{0.2}Fe_{0.8})O_{3-δ} (LSCF) electrodes, applied to opposite faces of the electrolyte disc.

FIG. 2 is a schematic diagram of the test configuration used for testing NO_{X} sensors of Examples 1 through 6.

FIG. 3 is a graph showing the effect of varying applied voltage on the composition of the gas stream exiting the sensor chamber, as described in Example 2.

FIG. 4 is a graph showing the sensor response and a mass spectrum of gas species exiting the sensor chamber during an experiment showing the sensor dependence on adsorbed NO_{X} without CO₂, as described in Example 2.

FIG. 5 is graph showing the sensor response and a mass spectrum of gas species exiting the sensor chamber during an experiment showing the sensor dependence on adsorbed NO_{X} with CO₂ in the gas stream, as described in Example 2.

FIG. 6 is a graph with a comparison of Tafel plots, showing responses of a planar sensor with symmetrically opposed electrodes in different baseline gases at 425° C., as described in Example 3.

FIG. 7 is a graph with a comparison of Tafel plots, showing responses of planar sensors with symmetrically opposed electrodes to NO and NH₃ at 375° C. in a baseline gas composition of 3.3 vol % O₂, 11.3 vol % CO₂, 2 vol % H₂O (balance N₂), as described in Example 3.

FIG. 8 is a graph showing the responses of a planar sensor with symmetrically opposed electrodes to NO₂ and NO at 425° C. in a baseline gas composition of 3.3 vol % O₂, 11.3 vol % CO₂, 2 vol % H₂O (balance N₂), as described in Example 3.

FIG. 9 is a graph showing the responses of planar sensors with symmetrically opposed electrodes at 425° C. made with and without GDC promoter additions to the sensing electrode, as described in Example 4.

FIG. 10 is a graph with a comparison of Tafel plots, showing responses of planar sensors with symmetrically opposed electrodes in different baseline gases at 425° C., as described in Example 5.

FIG. 11 is a graph with a comparison of Tafel plots showing responses of a planar sensor with symmetrically opposed electrodes to NO and NH₃ at 375° C. in baseline gas composition of 3.3 vol % O₂, 11.3 vol % CO₂, 2 vol % H₂O (balance N₂), as described in Example 5.

FIG. 12 is a graph showing the relative response of a planar NO_{X} sensor with symmetrically opposed electrodes to NH₃ (relative to 100 ppm NO) in a baseline gas composition of 5 vol % O₂ and 5 vol % CO₂ (balance N₂), as described in Example 5.

FIG. 13 is a graph showing the operation of a planar sensor with symmetrically opposed electrodes during cycles of 100 ppm NO in baseline gas composition of 3.3 vol % O₂, 11.3 vol % CO₂, 2 vol % H₂O, 1 ppm SO₂, (balance N₂) at 350° C. and 0.1 volts, as described in Example 6. After 15 hours, sensor was regenerated by heat treatment at 800° C.

FIG. 14 is a graph showing the response of a planar sensor with symmetrically opposed electrodes to step changes in NO_{X} concentration from 0 to 100 ppm at 400° C., with 0.25 volts applied to the sensor, and with a background oxygen level of 16 percent O₂ in a slip stream of a gasoline engine exhaust, compared to response of a commercial NO_{X} sensor manufactured by NGK Insulators, as described in Example 7.

FIG. 15 is a drawing of a sensor with both electrodes printed on the same side of a GDC substrate, as described in Example 8.

FIG. 16 is a graph showing the responses of a same-plane electrode sensor to 100 ppm NO at 350° C., as described in Example 8.

FIG. 17 is a drawing showing a same-plane electrode sensor made with interdigitated electrodes deposited on a thick-film of a GDC electrolyte membrane, as described in Example 9.

FIG. 18 is a graph showing the response of a same-plane electrode sensor made with interdigitated electrodes deposited on a thick-film of a GDC electrolyte membrane to repeated exposures to 100 ppm NO, with 0.1 volts applied across the sensor electrodes as described in Example 9.

FIG. 19 is a drawing showing an exploded view of a same-plane electrode sensor design, made with interdigitated electrodes deposited on a thick-film of GDC electrolyte membrane as described in Example 10. The design also includes a heater component to elevate the sensor temperatures to the target operating range of 200 to 550° C.

FIG. 20 is a diagram of the parts required for assembly of an integrated sensor that utilizes a planar sensor element with symmetrically opposed electrodes, as described in Example 1.

FIG. 21 is a diagram of a nearly assembled integrated sensor that utilizes a planar sensor element with symmetrically opposed electrodes, as described in Example 1.

FIG. 22 is a drawing of a sensor design with electrodes printed on opposite sides of a thick film of electrolyte, as described in Example 12. The design also includes a heater component to elevate the sensor temperatures to the target operating range of 200 to 550° C.

FIG. 23 is a graph showing the response of a same-plane electrode sensor made with interdigitated electrodes deposited on a thick-film of a GDC electrolyte membrane to repeated exposures to 100 ppm NO, with 0.1 volts applied across the sensor electrodes as described in Example 13.

These Figures demonstrate various features and embodiments of cells and sensors of the present invention, and methods employing the same, but are not to be construed as limiting of the invention.

### DETAILED DESCRIPTION OF THE INVENTION

The electrochemical cells and sensors of the present invention are described herein and in the following examples by reference to a limited range of electrolyte, electrode, optional catalytic materials, promoters, filter materials, and protective adsorbents. However, it is apparent in view of the present specification that the electrochemical cells and sensors will yield acceptable results with a wide range of such materials. In addition, while exemplary electrolyte and electrode film thickness are described, the invention includes all film thicknesses having acceptable mechanical integrity and electrochemical response.

In one embodiment, the invention is directed to an amperometric ceramic electrochemical cell comprising an electrolyte layer, a sensing electrode layer, and a counter electrode layer. The cell is operable in an oxidizing atmosphere and under an applied bias to exhibit enhanced reduction of oxygen molecules at the sensing electrode in the presence of one or more nitrogen oxides (NO_{X}) and/or ammonia (NH₃) and a resulting increase in oxygen ion flux through the cell. The sensing electrode and counter electrode may be made of the same or different materials, as will be set forth in further detail below. Additionally, the counter electrode can be exposed to the same gas environment as the sensing electrode, so that there is no requirement for an oxygen reference when the electrochemical cell is employed in a sensor. This provides a significant advantage over many sensors which require an oxygen reference. The counter electrode can be exposed to air as well, or, if desired, the an oxygen reference electrode can be provided in a sensor employing the inventive cell. In one embodiment, the cell is operable to exhibit the enhanced reduction of oxygen molecules at the sensing electrode in the presence of one or more nitrogen oxides and a resulting increase in oxygen ion flux through the cell in proportion to a concentration of nitrogen oxides in the oxidizing atmosphere. In another embodiment, sensor is operable to exhibit at least sixty percent of its equilibrium response to the presence of nitrogen oxides in less than one minute, or more specifically in less than one second, or more specifically in less than 200 milliseconds. The invention is also directed to sensors employing such cells.

In another embodiment, the invention is directed to an amperometric ceramic electrochemical cell comprising an electrolyte layer comprising a continuous network of a first material which is ionically conducting at an operating temperature of about 200 to 550° C.; a counter electrode layer comprising a continuous network of a second material which is electrically conducting at an operating temperature of about 200 to 550° C.; and a sensing electrode layer comprising a continuous network of a third material which is electrically conducting at an operating temperature of about 200 to 550° C., which sensing electrode is operable to exhibit increased charge transfer in the presence of one or more target gas species. In one embodiment, the electrolyte layer first material is oxygen ion conducting at the specified operating temperature. In a further embodiment, the electrolyte layer prevents physical contact between the counter electrode layer and the sensing electrode layer, and the cell is operable to exhibit conductivity to oxygen ions at an operating temperature of about 200 to 550° C. and increased or decreased resistance in the presence of the one or more target gas species. The invention is also directed to sensors employing such cells. In one such sensor, the sensor is operable to generate an electrical signal as a function of target gas concentration in an oxygen-containing gas stream, in the absence of additional sensing electrodes or oxygen pumping currents.

In yet another embodiment, the invention is directed to electrochemical cell for the amperometric detection of one or more gas species. The cell comprises an ionically conducting electrolyte membrane, a sensing electrode comprising an electrically conducting ceramic, and a counter electrode comprising an electrically conducting ceramic, cermet or metal, wherein the electrochemical cell is operable to pass current by reduction of oxygen at the sensing electrode, transport of oxygen ions through the electrolyte, and recombination of oxygen ions at the counter electrode layer. In specific embodiments, the sensing electrode is operable to exhibit varying catalysis of oxygen reduction in the presence of NO_{X} (one or more oxides of nitrogen), CO, CO₂, and/or SO_{X} (one or more oxides of sulfur), or, more specifically, the sensing electrode is operable to exhibit reversible adsorption of NO and NO₂ and varying catalysis of oxygen reduction in the presence of NO_{X}, CO, CO₂, and/or SO_{X}.

In additional embodiments, the invention is directed to an electrochemical cell for the amperometric detection of gas species comprising (a) an ionically conducting electrolyte comprising cerium oxide doped with Ca, Sr, Sc, Y, Pr, Nd, Pm, Sm, Eu, Gd, Tb, Dy, Ho, Er, Tm, Yb, La, or a mixture thereof; zirconium oxide doped with Ca, Mg, Sc, Y, Ce, or a mixture thereof; bismuth oxide doped with Y, V, Cu, Er or a mixture thereof; or lanthanum gallium oxide doped with Sr, Mg, Zn, Co, Fe or a mixture thereof; (b) a sensing electrode comprising lanthanide manganite perovskite material, doped with Ca, Sr, Ba, Fe, Co, Ni, Cu, Zn, Mg or a mixture thereof; lanthanide ferrite perovskite material, doped with Ca, Sr, Ba, Mn, Co, Ni, Cu, Zn, Mg or a mixture thereof; lanthanide cobaltite perovskite material, doped with Ca, Sr, Ba, Mn, Fe, Ni, Cu, Zn, Mg or a mixture thereof; lanthanide nickelate perovskite material, doped with Ca, Sr, Ba, Mn, Fe, Co, Cu, Zn, Mg or a mixture thereof; or lanthanide cuprate perovskite material, doped with Ca, Sr, Ba, Mn, Fe, Co, Ni, or a mixture thereof; and (c) a counter electrode comprising lanthanide manganite perovskite material, doped with Ca, Sr, Ba, Fe, Co, Ni, Cu, Zn, Mg or a mixture thereof; lanthanide ferrite perovskite material, doped with Ca, Sr, Ba, Mn, Co, Ni, Cu, Zn, Mg or a mixture thereof; lanthanide cobaltite perovskite material, doped with Ca, Sr, Ba, Mn, Fe, Ni, Cu, Zn, Mg or a mixture thereof; lanthanide nickelate perovskite material, doped with Ca, Sr, Ba, Mn, Fe, Co, Cu, Zn, Mg or a mixture thereof; lanthanide cuprate perovskite material, doped with Ca, Sr, Ba, Mn, Fe, Co, Ni, or a mixture thereof; or a metal material comprising Ni, Fe, Cu, Ag, Au, Pd, Pt, or Ir, or an alloy or a cermet thereof.

In a specific embodiment of such an electrochemical cell, the electrolyte comprises ionically conducting cerium oxide doped with Ca, Sr, Sc, Y, Pr, Nd, Pm, Sm, Eu, Gd, Tb, Dy, Ho, Er, Tm, Yb, La or a mixture thereof; the sensing electrode material comprises lanthanide ferrite perovskite material doped with Ca, Sr, Ba, Mn, Co, Ni, Cu, Zn, Mg or a mixture thereof, or lanthanide cobaltite perovskite material doped with Ca, Sr, Ba, Mn, Fe, Ni, Cu, Zn, Mg or a mixture thereof; and the counter electrode material comprises lanthanide ferrite perovskite material doped with Ca, Sr, Ba, Mn, Co, Ni, Cu, Zn, Mg or a mixture thereof, lanthanide cobaltite perovskite material doped with Ca, Sr, Ba, Mn, Fe, Ni, Cu, Zn, Mg or a mixture thereof, or a metal material comprising Ni, Fe, Cu, Ag, Au, Pd, Pt, or Ir, or an alloy or cermet thereof. In a more specific embodiment, the electrolyte is ionically conducting and comprises cerium oxide doped with Y, Nd, Sm, Gd, La or mixtures thereof; the sensing electrode is ionically and electronically conducting and comprises Sr and Co doped lanthanide ferrite, and the counter electrode is electronically conducting. In another embodiment, the electrolyte is ionically conducting and comprises Sm-doped cerium oxide electrolyte; the sensing electrode is ionically and electronically conducting and comprises Lanthanum Strontium Cobalt Ferrite, and the counter electrode is an electrically conducting and comprises Lanthanum Strontium Cobalt Ferrite.

In additional embodiments of the various electrochemical cells of the invention, suitable electrolyte materials for the disclosed cells and sensors may include gadolinium-doped ceria (GDC or Ce_{1-X}Gd_{X}O_{2-X/2}, where X ranges from approximately 0.05 to 0.40) or samarium doped ceria (SDC or Ce_{1-X}Sm_{X}O_{2-X/2}, where X ranges from approximately 0.05 to 0.40) including but not limited to the compositions described herein. Other ceramic electrolyte materials also may be suitable, including yttrium doped ceria (YDC), cerium oxide doped with other lanthanide elements or cerium oxide doped with two or more lanthanide or rare earth elements. Still other suitable electrolyte materials for the disclosed sensor may include: fully or partially doped zirconium oxide including but not limited to yttrium stabilized zirconia (YSZ) and scandium doped zirconia (ScSZ); alkaline earth zirconates and cerates; doped bismuth oxides, lanthanum gallate based ceramic electrolytes, such as (La_{1-X}Sr_{X})(Ga_{1-Y}Mg_{Y})O_{3-X/2-Y/2}, where X ranges from approximately 0.05 to 0.30 and Y ranges from approximately 0.05 to 0.30; other ceramic materials that conduct electricity predominantly via transport of oxygen ions; mixed conducting ceramic electrolyte materials; proton conducting electrolyte materials; and/or mixtures thereof. An interfacial layer of GDC, SDC or another suitable electrolyte material may be provided between an electrolyte substrate and electrode layers. Further sensing electrodes could be deposited onto a GDC, SDC or other suitable electrolyte material that is first deposited onto an aluminum oxide ceramic substrate or any other ceramic substrate material that is not an electrolyte material.

The sensing electrode may be a perovskite electrode composition having the general formula: (A_{1-X}A′_{X})_{1-Z}(B_{1-Y}B′_{Y})O_{3-δ}, where A is a tri-valent lanthanide element and A′ is a bi-valent rare-earth element. Suitable electrode materials may include (La,Sr)(Co,Fe)O₃ (LSCF) compositions, including but not limited to the specific compositions described herein. Other suitable electrode materials may include (La,Sr)(Mn)O₃ (LSM), (La,Sr)FeO₃ (LSF), (La,Sr)CoO₃ (LSC), LaNiO₃, (La,Sr)CuO_{2.5} (LSCu), (Sm,Sr)CoO₃ (SSC), (Pr,Sr)MnO₃ (PSM), (Pr,Sr)FeO₃ (PSF), (Pr,Sr)CoO₃ (PSC), La(Mn, Co)O₃ (LMC), La(Ni,Mn)O₃ (LNM), La(Ni, Co)O₃ (LNC) and La(Ni,Fe)O₃ (LNF). Suitable electrode materials also may be variants of the above electrode materials families listed above whereby lanthanum is replaced fully or partially by yttrium or the lanthanide series of cations, Sr is replaced fully or partially by the alkaline earth series of cations, examples including but not limited to (Ba,Sr)(Co,Fe)O₃ (BSCF). Suitable electrode materials also may be variants whereby solid solutions of the electrode families listed above are produced, for examples: (La,Sr)(Mn, Co)O₃ (LSMC), (Pr,Sr)(Mn, Co)O₃ (PSMC), and (Pr,Sr)(Mn,Fe)O₃ (PSMF). Further, suitable electrode materials may be doped versions of the above listed electrode materials families in which other transition metals are doped onto the B-site of the structure, for examples: (La,Sr)(Zn,Fe)O₃ (LSZF), (La,Sr)(Mg,Fe)O₃ (LSMgF), (La,Sr)(Ni,Fe)O₃ (LSNF), and (La,Sr)(Cu,Fe)O₃ (LSCuF). Further, non-perovskite electrode materials may be suitable, including layered perovskites, brownmillertites and other derivative structures, including but not limited to yttrium barium copper oxide (YBCO), La₂NiO₄, and GdBaCuO₅, Sr₂CO₂0₅Sr₂Fe₂O₅Sr₂FeCoO₅, and Sr₂Mn₂O₅.

The sensing electrode may also be a composite electrode comprising an electrode material (any of the above described electrodes) and an electrolyte material (any of the above described electrolyte formulations). The counter electrode composition may be the same as the sensing electrode composition, or the counter electrode may have a different composition from the sensing electrode. Suitable counter electrodes include those materials listed above, as well as any of the following: Ag, Au, Pt, Pd, Ru, Ir, Rh, alloys thereof, or any other conductive material known to catalyze the re-oxidation of oxygen ions to molecular oxygen.

Catalytic or electrocatalytic promoters may be included in the electrodes, particularly the sensing electrode, to improve performance. Such promoters which may optionally be incorporated into the electrode material to improve performance may include, but are not limited to, the following or any combination of the following: Ag, Au, Pt, Pd, Ru, Ir, Ni, Fe, Cu, Sn, V, Rh, Co, W, Mo, U, Zn, Mn, Cr, Nb or other compositions known to catalyze oxidation of hydrocarbons, CO, NH₃, carbon, and other reductants that may interfere with sensor response. If the promoter is catalyzing carbon oxidation, the promoter will also assist in protecting the sensor from fouling. In additional embodiments, the promoter may comprise cerium or doped cerium oxide, an alkali metal, or an alkaline earth metal. Additionally, in specific embodiments, the promoter may be added to equilibrate the NO to NO₂ ratio in the gas stream, to promote NO_{X} or NH₃ adsorption, i.e., the capacity or rate of NO_{X} or NH₃ adsorption, to oxidize NO to NO₂, or to selectively enhance oxygen reduction in the presence of NO_{X}.

Promoters that may be added to enhance the capacity or rate of NO_{X} adsorption, include but not limited to potassium, barium, sodium, lanthanum, calcium, strontium, magnesium, and lithium or other alkali or alkaline earth metals and any combination of these materials. Promoters may also be added to decrease electrical resistance of the cell in the absence of NO_{X}, i.e., to reduce oxygen reduction on the sensor electrode in the absence of NO_{X}, thus improving NO_{X} selectivity over the operating range of the sensor (temperature, voltage, etc.). In this embodiment, the promoter can be viewed as an inhibitor. Such promoters include, but are not limited to, chlorine, fluorine, potassium, barium, sodium, calcium, lanthanum, strontium, magnesium, and lithium or any combination of these materials. Promoters may also be added to enhance selectivity to SO_{X}, NH₃, or other gases to tune the sensor to detection of these gases.

Sensors of different formulations could be coupled to detect multiple gases and provide enhanced selectivity. For example, a Gd_{X}Ce_{1-X}O_{2-X/2} (GDC), ceramic electrolyte membrane with La_{1-X}Sr_{X}Fe_{1-Y}Co_{y}O_{3-δ} (LSCF) electrodes has greater sensitivity to NO_{X} than to NH₃. By combining these sensors with the appropriate electronics, the responses to both NO_{X} and ammonia can be discerned.

Filter materials and/or protective adsorbent materials may be added to protect the sensor from poisons in the exhaust stream including particulate matter, soot, sulfur compounds, silicon compounds, engine oil contaminants such as phosphorous, zinc, and calcium compounds, lead, road salt, and other application contaminants. These protective materials may be added to the electrode or electrolyte material composition, may be infiltrated into the electrode layer, or may be applied as a coating onto the electrode layer. In a specific embodiment, a protective material is printed on the cell to cover the electrodes. These materials may be porous in structure and include, but are not limited to, zeolite materials, aluminum oxide, electrolyte materials (as listed above), molybdenum oxide, zinc oxide, tungsten oxide or any other materials that provide a physical or chemical filter and/or have an affinity to preferentially adsorb these contaminants.

For optimum NO_{X} selectivity, the sensor is operated in the range of 200 to 550° C. with an applied bias of from about 0.01 to about 1 volt, or, in more specific embodiments, with an applied bias of about 0.05 to about 0.4 volts, or with an applied bias of about 0.1 to about 0.5 volts. The operating temperature range may be modified to achieve improved selectivity to other gases such as ammonia, SO₂, CO₂ and O₂. Additionally the applied voltage may be constant or varying. In a specific embodiment, the sensor is operated with a constant applied bias in the indicated ranges. Alternatively, the sensor may be operated with an applied bias that is modified either to a different range or to an alternating polarity mode, whereby the voltage is cycled between a negative applied voltage and positive applied voltage. The frequency of this cycling may also be adjusted to enhance sensitivity, selectivity, and poison resistance of the sensor. The sensor may also be periodically exposed to a different set of operating conditions such as higher temperature or applied voltage, or a cycled voltage to remove and/or prevent poisoning from sulfur, silica, hydrocarbon particulate matter, or other contaminants. For example, a sensor device can be constructed with two different electrode materials, one that is sensitive to NO_{X} and a second that is sensitive to NH₃, and by alternating the polarity and/or magnitude of the applied voltage across the electrodes, both NO_{X} and NH₃ can be measured in a single sensor.

In a specific embodiment, an electrochemical cell comprising an electrolyte layer, a sensing electrode layer, and a counter electrode layer, according to the invention is operable in an oxidizing atmosphere and under a first applied bias to exhibit enhanced reduction of oxygen molecules at the sensing electrode in the presence of one or more nitrogen oxides (NO_{X}) and a resulting increase in oxygen ion flux through the cell and is operable in the oxidizing atmosphere and under a second applied bias different from the first applied bias to exhibit enhanced reduction of oxygen molecules at the sensing electrode in the presence of NH₃ and a resulting increase in oxygen ion flux through the cell. In another embodiment, an electrochemical cell comprising an electrolyte layer, a first electrode layer, and a second electrode layer according to the invention is operable in an oxidizing atmosphere and under a first applied bias to exhibit enhanced reduction of oxygen molecules at the first electrode in the presence of one or more nitrogen oxides (NO_{X}) and a resulting increase in oxygen ion flux through the cell and is operable in the oxidizing atmosphere and under a second applied bias different from the first applied bias to exhibit enhanced reduction of oxygen molecules at the second electrode in the presence of NH₃ and a resulting increase in oxygen ion flux through the cell. Alternatively, a sensor may include a combination of cells according to the invention. In a specific embodiment of such, a sensor comprises (a) a first amperometric ceramic electrochemical cell comprising an electrolyte layer, a sensing electrode layer, and a counter electrode layer, wherein the cell is operable in an oxidizing atmosphere and under a first applied bias to exhibit enhanced reduction of oxygen molecules at the sensing electrode in the presence of one or more nitrogen oxides (NO_{X}) and a resulting increase in oxygen ion flux through the cell and is operable in the oxidizing atmosphere; and (b) a second amperometric ceramic electrochemical cell comprising an electrolyte layer, a sensing electrode layer, and a counter electrode layer, wherein the cell is operable under a second applied bias different from the first applied bias to exhibit enhanced reduction of oxygen molecules at the sensing electrode in the presence of NH₃ and a resulting increase in oxygen ion flux through the cell.

The cells and sensors of the invention may be configured to be compatible with various application environments, and may include substrates with modifications to provide structural robustness, addition of a heater to control sensor temperature, modifications to the electrolyte geometry and overall sensor size and shape, external packaging and shielding to house and protect the sensor, and appropriate leads and wiring to communicate the sensor signal to the application. The sensor technology is applicable to both planar and tubular geometries. Additionally, multiple electrochemical cells with different electrode formulations may be employed in a single sensor device to enable detection of multiple gas species. Electrodes may be located on the same side or on opposing sides of the electrolyte later. Additionally, the sensor may comprise multiple electrochemical cells to increase signal levels. Exemplary embodiments include, but are not limited to, electrochemical cells and sensors wherein the electrode layers are symmetrically opposed to one another on each side of the electrolyte layer, whereby oxygen ion current flows through a thickness of the electrolyte; wherein the electrode layers are laterally spaced on a single surface of the electrolyte layer, with an uncoated area of the surface of the electrolyte layer between the electrode layers; wherein the electrode layers are interspaced to form an interdigitated or interlocking design of electrodes of opposite polarity while maintaining a minimal electrode path length therebetween; and/or wherein the electrolyte layer has a hollow tubular configuration, and the electrode layers are applied internally and/or externally to the electrolyte layer. In one configuration, the electrolyte is a porous component and prevents physical contact between the electrode layers.

A substrate may be included in the sensors of the invention, in combination with the described electrochemical cells, for example to provide mechanical support, and may comprise any suitable insulating material, for example, an insulating ceramic or a metal or cermet material coated with an insulating material. In one embodiment, a sensor includes a zirconia substrate, or more specifically, a yttrium-stabilized zirconia (YSZ) substrate. The sensor may optionally include a heater which is electrically isolated from the electrolyte and electrodes. The heater may be a resistive heater formed, for example, from a conductive metal such as, but not limited to, platinum, silver, or the like. The heater may, for example, be applied to or embedded in the substrate, or applied to the cell through another insulating layer such as aluminum oxide.

Various features and advantages of the amperometric sensor described in this invention will become evident from the devices and results obtained as described under the following Examples.

### Example 1

### Sensor Fabrication and Testing Method

Symmetrically electroded electrolyte membrane discs were used to test the fundamental sensing properties of this invention and confirm the sensing mechanism, as will be described in Examples 2 through 7. Planar electrochemical cells were fabricated using a gadolinium doped ceria (Ce_{0.9}Gd_{0.1}O_{1.95}, GDC) electrolyte membrane with (La_{0.60}Sr_{0.40})(Co_{0.20}Fe_{0.80})O_{3-δ} (LSCF) electrodes applied to opposite sides. The electrolyte membrane in a disc form, shown in FIG. 1a, consists of a self-supporting electrolyte membrane of GDC, with an effective thickness of 40 microns. As disclosed in U.S. patent application Ser. No. 11/109,471 (published Oct. 19, 2006 as US 2006/0234100 A1), incorporated herein by reference in its entirety, the membrane is mechanically supported by an additional thicker doped ceria layer, in a perforated design approximately 100 microns thick which is simultaneously sintered with the membrane layer. As shown in FIG. 1b, the active area of the sensor is defined by the area of the deposited electrodes, which are symmetrically deposited on the opposite sides of the membrane disc and then annealed.

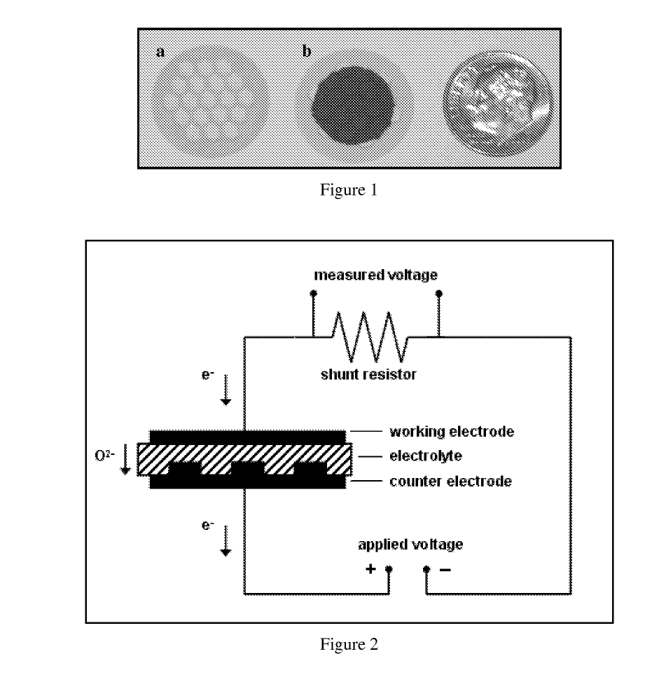

For testing, the sensor is placed in a simulated fuel-lean diesel exhaust atmosphere, with temperature controlled over the approximate range of 200 to 550° C., and a constant voltage in the range of approximately 0.1 to 0.5 volts is applied to the cell. Voltage is measured across a shunt resistor, in series with the sensor, to determine the current passing through the cell, with various gases (NO_{X}, NH₃, and/or SO_{X}) being introduced into the simulated diesel exhaust atmosphere. The testing configuration is shown in FIG. 2.

### Example 2

### Demonstration of Sensing Mechanism

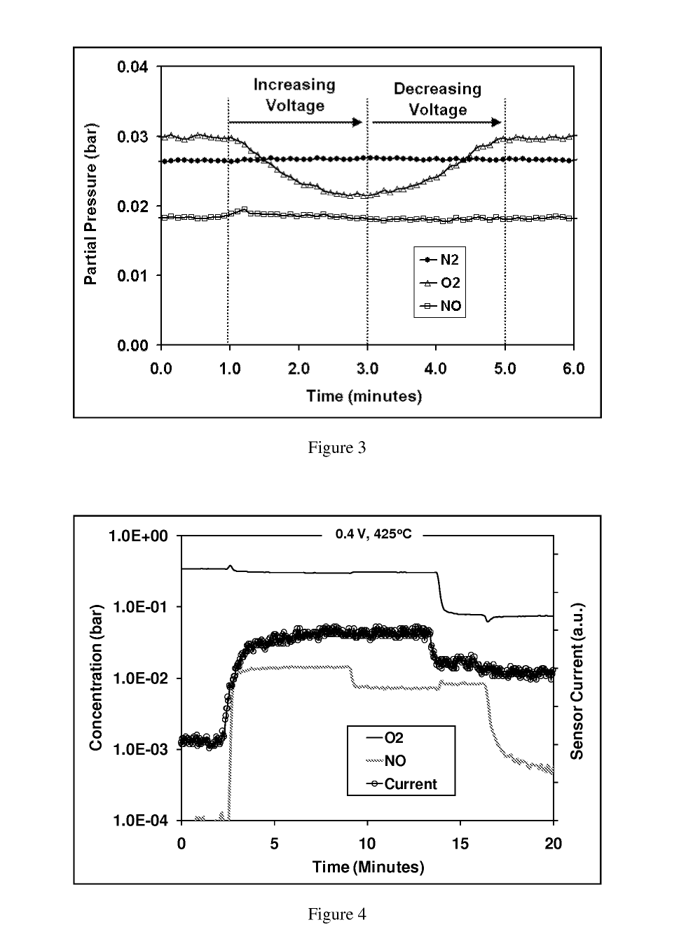

In this example, experiments were conducted to demonstrate the disclosed sensing mechanism of this invention. Specifically, experiments were designed to show that NO_{X} is not reduced during the application of a voltage; only oxygen is reduced at the sensing electrode, the oxygen ions then being re-oxidized to molecular oxygen at the counter electrode. For these experiments, a sensor was fabricated as described in Example 1. The sample was loaded into a test chamber, such that the sensing and counter electrodes were sealed from one another, with the counter electrode being exposed to air, and the sensing electrode exposed to the gas stream being sensed. The gas composition was monitored downstream of the sensor to determine the effect of the electrochemical cell on the gas composition. During a sweep in the applied voltage, a corresponding drop in oxygen concentration was observed, indicating that oxygen was being pumped through the cell (see FIG. 3). The lack of change in nitric oxide composition indicates it was not being consumed in the process, but because the current is higher in the presence of NO_{X}, it is having a catalytic effect on oxygen reduction. It should be noted that the increase in current achieved in this test exceeds the amount possible through NO reduction to nitrogen, meaning the sensor has a higher response than an amperometric sensor based on NO_{X} reduction.

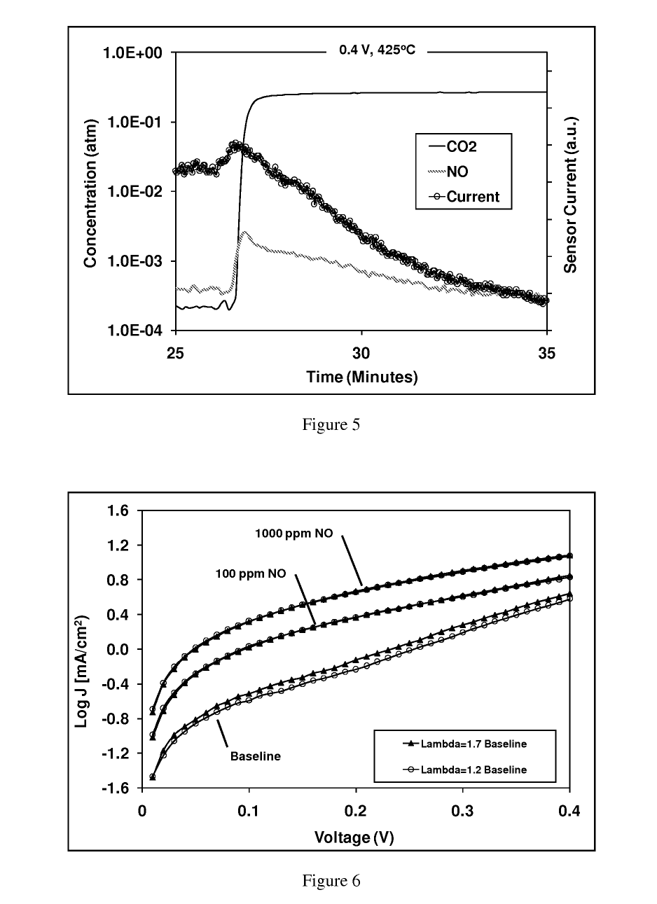

The catalytic effect of NO or NO₂ is present as long as NO_{X} is adsorbed, as shown in FIG. 4 and FIG. 5. In FIG. 4, while the sensor is operating at an applied voltage of 0.4 volts, 100 ppm of NO is added to the gas stream, causing an increase in current. The current changes slightly when the oxygen level is adjusted, but is not dramatically affected when NO is removed. However, when carbon dioxide is added to the feed, NO is observed to desorb from the sensor, and the current drops (see FIG. 5). In an actual hydrocarbon combustion exhaust, CO₂ always will be present, allowing the sensor to recover quickly from an exposure to NO_{X}. Additionally, in an actual sensing environment, the sensing and counter electrodes do not need to be sealed from one another, and both electrodes could be exposed to the gas being sensed.

### Example 3

### Demonstration of Response Sensitivity to NO_{X}

In this example, the response characteristics of the sensor to NO and NO₂ were evaluated, and experiments were conducted to demonstrate that the sensing mechanism is effective over a range of applied voltage, exhaust gas atmospheres, and temperatures, and is effective for NO and NO₂. A sensor was fabricated as described in Example 1. The sensor was then loaded into a test chamber such that both electrodes were exposed to the same gas environment. In this configuration, the responsiveness of the sensor at 425° C. to varying atmospheres at varying applied voltages is shown in FIG. 6, in the form of Tafel plots. Two different baseline gases were examined for these tests:
(1) the λ=1.2 gas contained 3.3 vol % O₂, 11.3 vol % CO₂, 2 vol % H₂O, the balance being an inert gas (N₂).
(2) the λ=1.7 gas contained 8.3 vol % O₂, 8.1 vol % CO₂, 2 vol % H₂O, the balance being an inert gas (N₂).

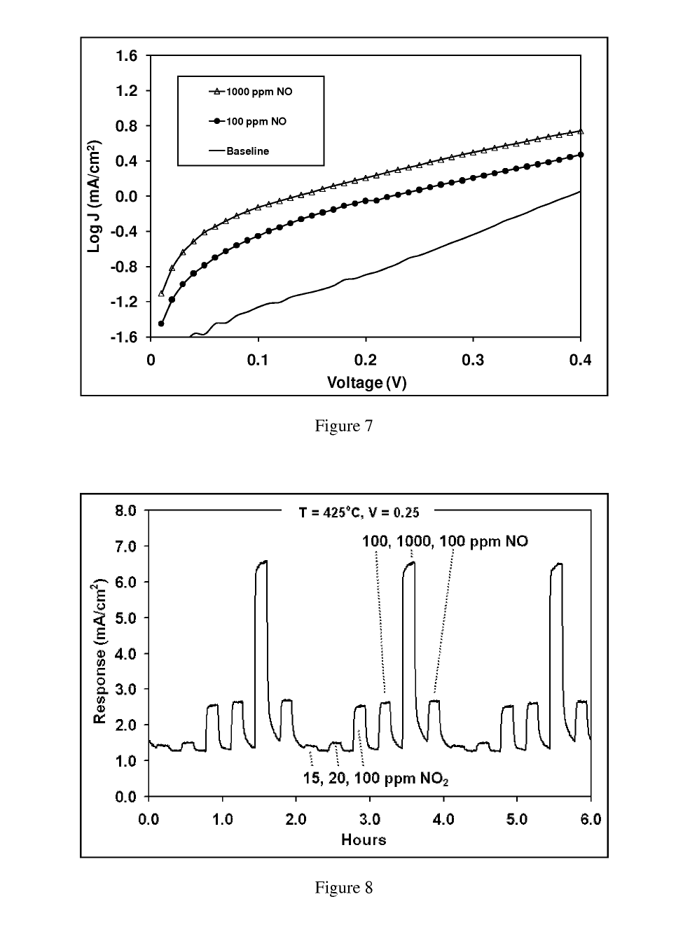

For each baseline gas, the effect of NO (100 and 1000 ppm), was examined. As can be observed in FIGS. 6 and 7, the presence of NO increases the oxygen reduction current over the range of applied voltages much more than the difference in current caused by changing the composition of the baseline gas. This holds true for tests conducted at approximately 550° C. and lower, although the baseline currents at about 200° C. become prohibitively low for accurate measurements.

Experiments were also conducted to quantify the relative sensitivity of the sensor to NO and NO₂. A sensor was fabricated as described in Example 1 and evaluated for its relative sensitivity to NO and NO₂. In this experiment, sensors were placed in a gas blending chamber through which simulated exhaust gas (baseline of 5 vol % O₂, 5% CO₂, 3 vol % H₂O, 10 ppm NO₂, balance N₂) was introduced at a constant flow rate of 200 sccm. NO and NO₂ test gases were each separately blended into the gas stream, and the resulting amperometric sensor output was measured in the previously described test configuration. As shown in FIG. 8, the response of the sensor is independent of whether NO_{X} is in the form of NO or NO₂. In the presence of oxygen, it is likely that NO and NO₂ form interchangeably on the electrode surface. As FIG. 8 illustrates, the sensor displays equal sensitivity to NO and NO₂, compared at the 100 ppm NO and NO₂ peaks. This further supports the mechanism that the adsorbed NO and NO₂ on the sensor surface catalyze the oxygen reduction reaction. In contrast, sensor technologies based on reducing NO₂ and NO to N₂ and O₂ display sensitivity to NO₂ two times greater than to NO. FIG. 8 also shows the difference in sensor response from 15 ppm to 1000 ppm changes in NO_{X} concentration, demonstrating the proportionality of the sensor response over this wide range.

### Example 4

### Demonstration of Effect of Promoter Addition to NO_{X} Sensitivity

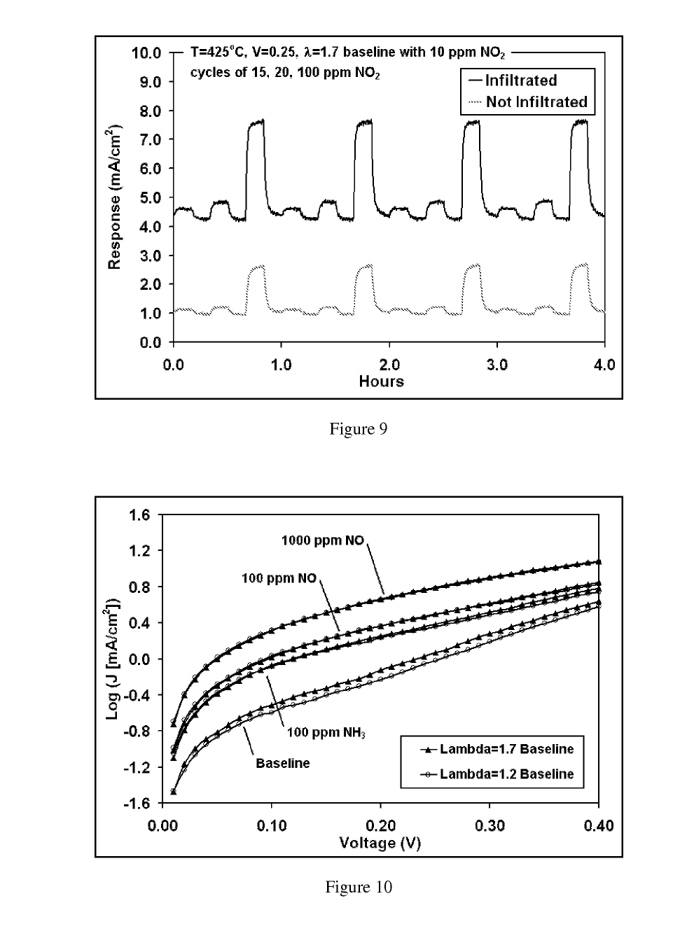

In this example, the effect of the sensor response characteristics upon addition of a promoter to the electrode were examined. A sensor was fabricated as described in Example 1. The electrodes of the sensor were then infiltrated with an aqueous cerium nitrate solution using an incipient wetness approach. The infiltrated sensor was then dried and annealed, leaving a dispersed ceria phase within the electrode (approximately 5 percent of the electrode by weight). As shown in FIG. 9, the ceria-infiltrated sensor demonstrated higher current density and a larger response to NO₂ than a sensor without the infiltration when tested at 425° C. and 0.25 volts in a simulated exhaust stream. The infiltrated sensor, therefore, has the advantage of higher current per given electrode area, and a larger change in current during exposure to NO_{X}, improving the corresponding signal strength for a given electrode area.

### Example 5

### Demonstration of Response Sensitivity to Ammonia

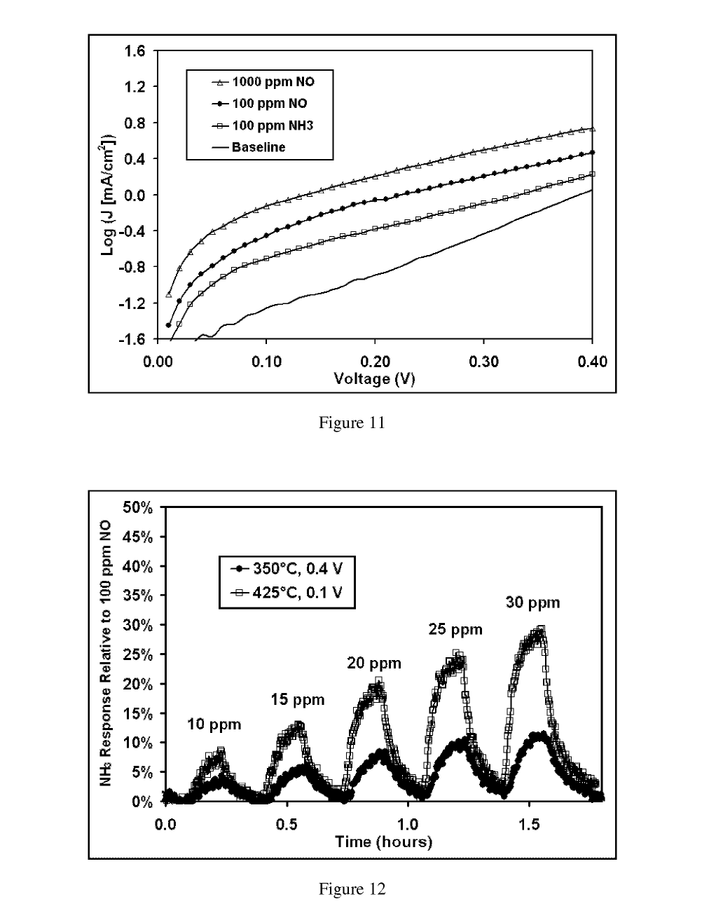

In this example, the response characteristics of the sensor to ammonia were evaluated. A sensor was fabricated and tested, as described in Example 1. 100 ppm of ammonia was added to each of the background gas formulations, and the response was measured. FIG. 10 shows the responsiveness of the sensor at 425° C. to varying atmospheres at varying applied voltages, shown in the form of Tafel plots. As can be observed in FIG. 10, the presence of NH₃ increases the oxygen reduction current over the range of applied voltages much more than the difference in current caused by changing the baseline gas. This holds true for tests conducted at about 550° C. and lower, although the baseline currents at about 200° C. become prohibitively low for accurate measurements. A comparison to FIG. 11 shows that the relative response of the sensor to NO_{X} and NH₃ is dependent on the voltage and the temperature of operation. At lower temperatures and higher voltages, the NO_{X} response becomes greater than the ammonia response at equivalent conditions. Therefore, by employing multiple sensors at different temperatures and/or voltages, or alternating the voltage of a single sensor, a combined NO_{X} and ammonia sensor could be envisioned.

This concept is illustrated in FIG. 12. In this experiment, NH₃ was introduced in concentrations ranging from 0 to 30 ppm. The sensor exhibited a strong cross-sensitivity to ammonia under higher temperature and lower applied voltage conditions (425° C., 0.1 volts), but displayed significantly lower sensitivity at lower temperature and higher applied voltage conditions (350° C., 0.4 volts). At 30 ppm, the ammonia sensitivity was almost 30 percent of the response to 100 ppm NO at the 425° C. condition; however, the response dropped to only 11 percent at the 350° C. condition. By manipulating these operating conditions through the sensor's electronics controller, this variable sensitivity to ammonia with respect to the NO_{X} response could enable both the NO_{X} and NH₃ concentrations to be determined in a single sensor.

### Example 6

### Demonstration of NO_{X} Sensitivity in the Presence of SO_{X}

In the targeted diesel exhaust application, a NO_{X} sensor may be exposed to a range of SO_{X} levels, continuously or intermittently. In this example, the sensitivity of the sensor to SO_{X} was evaluated. Sensors were fabricated as describe in Example 1 and tested for sensitivity to SO_{X} by injecting 1 ppm SO₂ into a simulated exhaust stream. As FIG. 13 shows, 20 percent degradation in responsiveness was observed over 15 hours; however, by increasing the temperature to 800° C., complete reversal of this degradation was observed. This allows the electronics of the sensor device to be designed with a periodic excursion to an elevated temperature as a means of mitigating the effect of SO₂ on the sensor response. In the ideal configuration, this excursion would not require heating a furnace, and could therefore take place much faster.

### Example 7

### Demonstration of Response Time

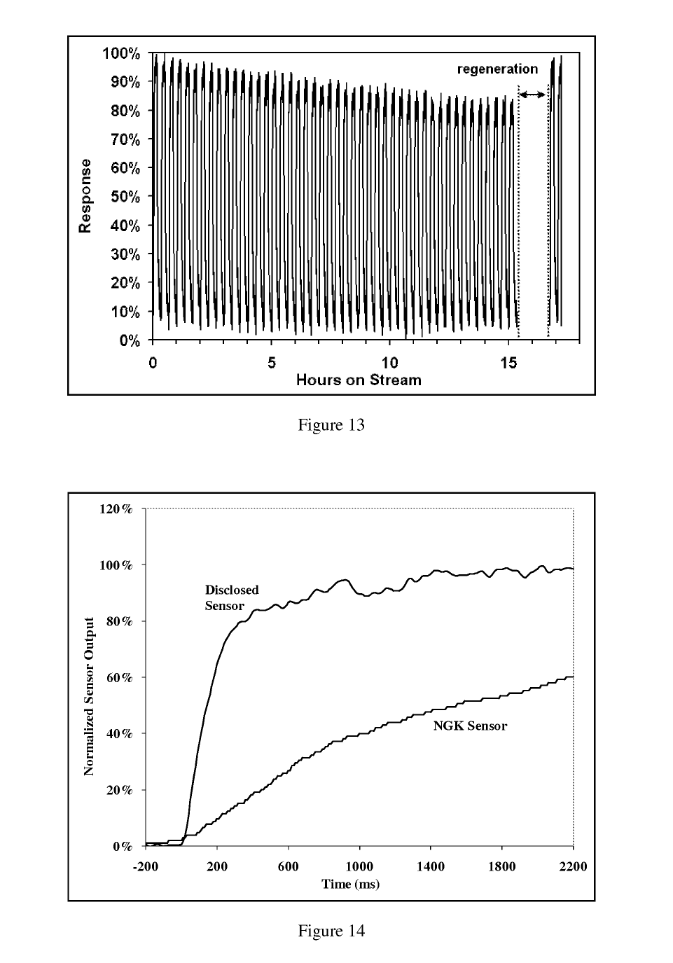

In this example, the response time of the sensor to detect NO_{X} was evaluated in the exhaust stream of a gasoline engine dynamometer. A sensor was fabricated as described in Example 1, and then clamped between steel washers and mounted in a slip stream of the post three-way catalyst exhaust, equipped with a gas heater to elevate the exhaust gas temperature to 400 to 450° C. The engine was stabilized at exhaust conditions containing 8.9 percent O₂ and 8.7 percent CO₂. NO and NO₂ were injected from bottled gas cylinders directly into the exhaust stream, just upstream of the sensor at concentrations ranging from 1 to 100 ppm. As shown in FIG. 14, response times of approximately 180 mS were observed, determined as time to reach 60 percent of the sensor's stabilized output. A commercial NO_{X} sensor, manufactured by NGK Insulators, was tested in the same manner, and the response of this sensor also is shown in FIG. 14. The response time of the NGK sensor was on the order of 2-3 seconds, an order of magnitude slower than the disclosed sensor. Further, the response time of the disclosed sensor is much faster than other amperometric and potentiometric technologies reported in the literature.

### Example 8

### Planar Sensor with Electrodes Printed on Same Side of GDC Electrolyte

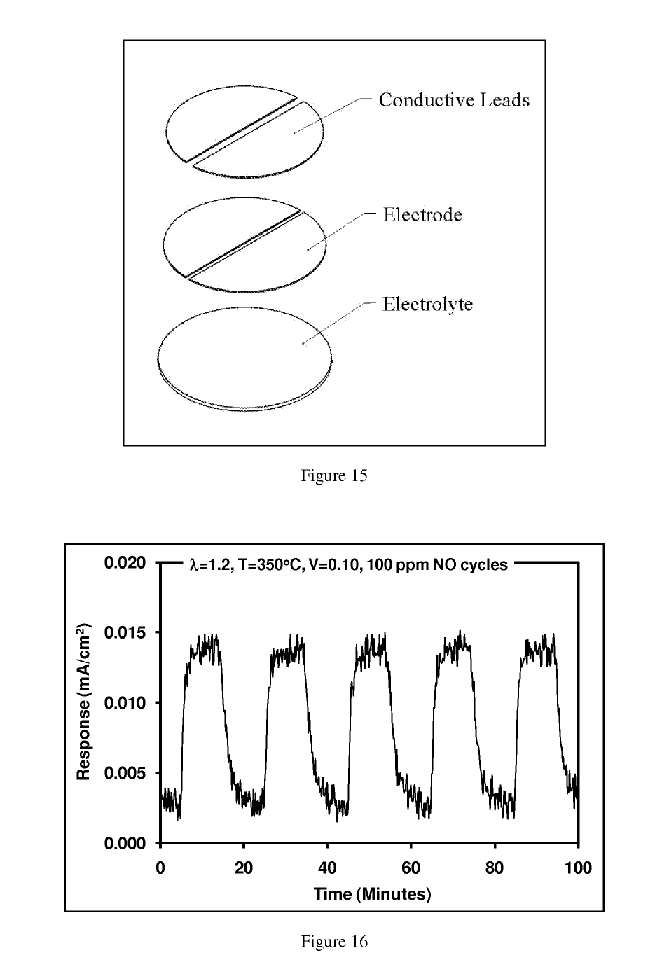

For improved manufacturability, sensors were built with both electrodes printed on one face of the electrolyte substrate. In this example, two LSCF electrodes were printed onto one face of a GDC ceramic electrolyte disc having a thickness of approximately 0.3 mm. As shown in FIG. 15, the substrates were semicircular in shape with a gap between them of approximately 0.3 mm. Gold was then printed on top of the LSCF electrode pattern to facilitate current collection. For testing, the sensor was placed in a simulated fuel lean diesel exhaust atmosphere, heated to 350° C. with furnace heat, and a constant voltage of approximately 0.1 volts was applied to the cell. Voltage was measured across a 100 ohm shunt resistor, in series with the sensor, to determine the current passing through the cell. The response of this sensor configuration is shown in FIG. 16, showing a repeatable step change response to 100 ppm NO.

### Example 9

### Same Plane, Interdigitated Electrode Configuration, Thick Film of GDC

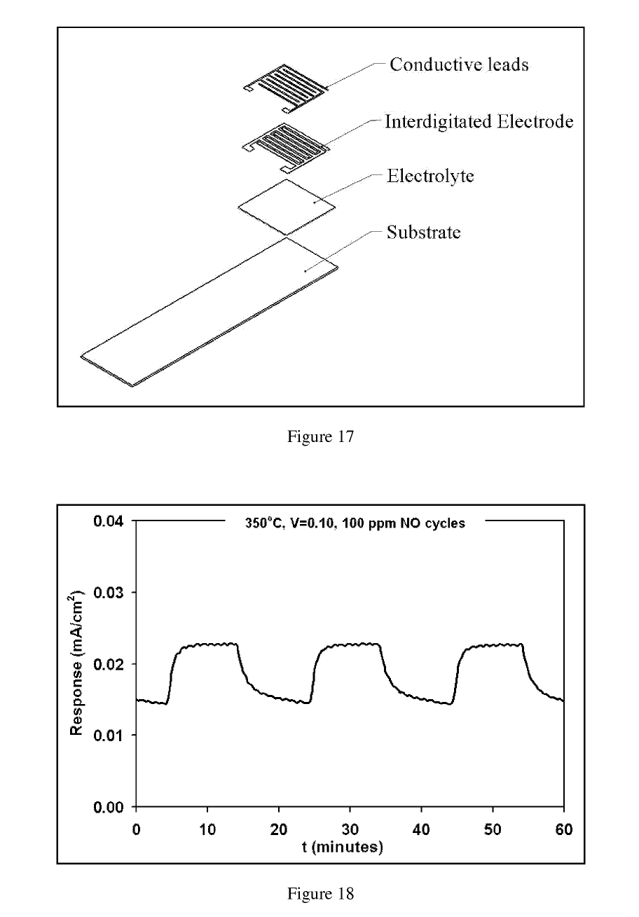

In this example, further design modifications were made over Example 8 to improve the manufacturability of the sensor design. In this example, a thick film (˜0.050 mm thick) of GDC was printed onto an yttrium stabilized zirconia (8 mol % Y₂O₃ or YSZ) substrate (approximately 0.150 mm thick) and sintered to densify the GDC electrolyte film. LSCF electrodes were printed on top of the GDC thick film in an interdigitated electrode pattern, as shown in FIG. 17. Gold was then printed on top of the LSCF electrode pattern to facilitate current collection. For testing, the sensor was placed in a simulated fuel-lean diesel exhaust atmosphere, heated to 350° C. with furnace heat, and a constant potential of approximately 0.1 volts was applied to the cell. Voltage was measured across a shunt resistor, in series with the sensor, to determine the current passing through the cell. The response of this sensor configuration is shown in FIG. 18, showing a repeatable step change response to 100 ppm NO.

### Example 10

### Interdigitated Electrode Configuration with Integrated Heater

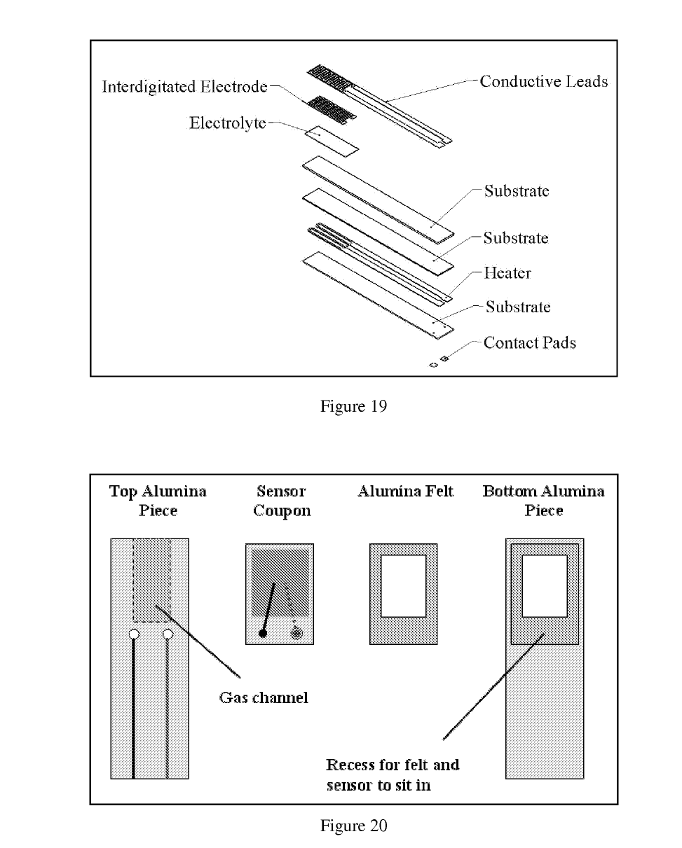

In this example, further modifications were made to the sensor design over Example 9, for ease of use in an exhaust environment (FIG. 19). In this design, a thick film of GDC is applied, over a length of approximately 10 to 15 mm from, the end of a YSZ substrate of nominal dimensions of 6 mm wide by 50 mm long. LSCF electrodes are applied in an interdigitated electrode pattern over the GDC print, and gold is applied in the same IDE pattern to carry the signal back to the data acquisition system. A separate heater is attached to this sensing element to enable the sensor temperature to be controlled to the target operating temperature. The resistive heater is made from Pt or other precious metal alloy and is applied to an aluminum oxide substrate of the same nominal dimensions as the YSZ component. The heater is attached to the YSZ component with a high temperature ceramic adhesive. Alternatively, the YSZ layers could be replaced with aluminum oxide, allowing the sensor and heater components to be one monolithic component. An optional porous protective coating could be applied to protect active sensing region from particulate matter.

### Example 11

### Sensor Packaging for Symmetrically Electroded Planar Sensor Elements

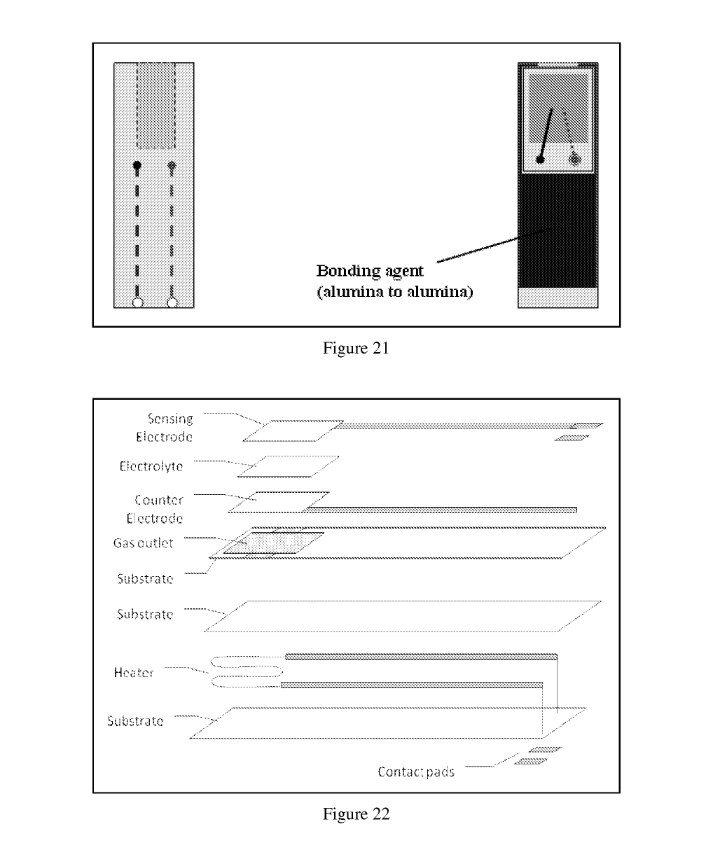

This example describes a packaging approach for utilizing symmetrically electroded sensing elements fabricated as described in Example 1. A drawing of the packaging design is shown in FIG. 20. Four pieces are required for assembly of the sensor. Two pieces of alumina serve as the housing for the sensor coupon. The bottom piece contains a hole for exposure to the sensing gas, and a recess in which a piece of alumina felt is placed. The felt is a compliant material that prevents the sensor from being crushed when the alumina pieces are adhered to one another. The sensor coupon is then placed on the alumina felt. The coupon consists of a solid planar ceria electrolyte with electrodes on each side. Metallic (e.g., gold or platinum) pads are painted on each electrode, with the pad on the bottom of the sensor leading to a hole in the electrolyte. The hole is filled with metallic ink to establish contact of the bottom electrode to the same side of the coupon as the top electrode. The top alumina piece is attached to the bottom piece with a bonding agent, such as ceramic cement that binds alumina to alumina (see FIG. 21 for placement of bonding agent). The top piece contains a channel (or hole) that allows oxygen being pumped to that electrode to escape. The electrical pads may be painted on the top or bottom of the top alumina piece. If painted on the top, as in FIG. 20, then the top piece would require holes that would be filled with metallic ink. In this configuration, the coupon would be mechanically attached to the top alumina piece via the electrical leads. This would have the advantage of preventing the sensor to move around within the recess, but the disadvantage would be that the leads could break at this joint, and electrical contact would be lost.

In the configuration shown in FIG. 21, the leads are placed on the bottom of the top alumina piece. With this configuration the leads on the coupon and the leads on the alumina are electrically connected, but not mechanically connected. The advantage of this approach is that there is no mechanical joint to break and loose contact, the spring constant of the felt keeps the two contacts connected. However, this approach has the disadvantages in the fact that the coupon could slide around more and possible break, or vibrations may cause a loss of electrical connection momentarily (or over time if the felt spring constant changes).

In either configuration, a heater would be placed on one or both faces of the sensor. A symmetrical assembly could also be envisions were a second sensor assembly is placed on the opposite side of the heater. This could allow for doubling the sensor output or for detection of alternative species, such as ammonia. The sensor(s) would be placed within a shield for further protection. The bottom of the sensor would extend out of the shield and lead to the electrical connections. A sealant at the bottom would bond the sensor element to the shield and keep exhaust gases from escaping, as is done in commercial oxygen sensors.

### Example 12

### Sensor with Electrodes Deposited on Opposite Sides of Thick Film Electrolyte Layer

In this example, an alternative sensor configuration was designed to with electrodes printed on opposite sides of a thick film GDC electrolyte layer (FIG. 22). In this design, the counter electrode is deposited onto a YSZ substrate of nominal dimensions of 6 mm wide by 50 mm long. A thick film of GDC (approximately 0.20 to 0.50 mm) is applied over the counter electrode. An LSCF sensing electrode is applied over the GDC print, and gold is applied over the LSCF to carry the signal back to the data acquisition system. With this configuration, the separation between electrodes (dictated by the thickness of the GDC layer) is minimized compared to the interdigitated electrode approach of Example 10, in which case the spacing between electrodes is limited by the capability of manufacturing methods such as screen or ink jet printing of electrode inks. A porous or fugitive gas outlet is included directly under the counter electrode to allow the recombined oxygen gas molecules to exit the sensor from the counter electrode. Alternatively, the electrolyte layer or counter electrode could be designed with sufficient porosity to allow for venting of the oxygen, thus eliminating the need for the gas outlet.

A separate heater is attached to this sensing element to enable the sensor temperature to be controlled to the target operating temperature. The resistive heater is made from Pt or other precious metal alloy and is applied to an aluminum oxide substrate of the same nominal dimensions as the YSZ component. The heater is attached to the YSZ component with a high temperature ceramic adhesive. Alternatively, the YSZ layers could be replaced with aluminum oxide, allowing the sensor and heater components to be one monolithic component. An optional porous protective coating could be applied to protect active sensing region from particulate matter.

### Example 13

### Demonstration of Alternative Electrode Composition

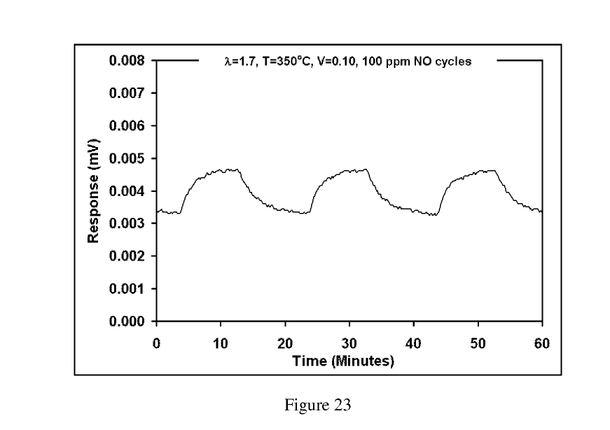

This example describes a variation in the electrode composition that exhibits response to nitrogen oxides. A sensor was prepared in the same configuration and procedure to that described in Example 9. However, instead of printing LSCF electrodes on the sensor, a composite of 50 wt % of (La_{0.60}Sr_{0.40})(Zn_{0.10}Fe_{0.90})O_{3-δ} (LSZF) and 50 wt % of GDC, with a 1-wt % addition of palladium as a promoter, was printed onto the GDC film in an interdigitized pattern. Gold leads were printed on the electrodes. For testing, the sensor was placed in a simulated fuel-lean diesel exhaust atmosphere, heated to 350° C. with furnace heat, and a constant potential of approximately 0.1 volts was applied to the cell. Voltage was measured across a shunt resistor, in series with the sensor, to determine the current passing through the cell. The response of this sensor composition is shown in FIG. 23, showing a repeatable step change response to 100 ppm NO.

The specific illustrations and embodiments described herein are exemplary only in nature and are not intended to be limiting of the invention defined by the claims. Further embodiments and examples, and the advantages thereof, will be apparent to one of ordinary skill in the art in view of this specification and are within the scope of the claimed invention.

What is claimed:

1. An amperometric ceramic electrochemical cell, comprising an electrolyte layer, a sensing electrode layer, and a counter electrode layer, wherein the cell is operable in an oxidizing atmosphere and under an applied bias to exhibit enhanced reduction of oxygen molecules at the sensing electrode in the presence of one or more nitrogen oxides (NO_{X}) and/or ammonia (NH₃) and a resulting increase in oxygen ion flux through the cell.

2. The electrochemical cell of claim 1, wherein the cell is operable to exhibit the enhanced reduction of oxygen molecules at the sensing electrode in the presence of one or more nitrogen oxides and a resulting increase in oxygen ion flux through the cell in a temperature range of about 200 to 550° C., or more specifically, in a temperature range of about 250 to about 450° C.

3. The electrochemical cell of claim 1, wherein the constant applied bias is in a range of about 0.1 to about 1 volt, or more specifically in a range of about 0.1 to about 0.4 volt.

4. The electrochemical cell of claim 1, wherein the cell is operable to exhibit the enhanced reduction of oxygen molecules at the sensing electrode in the presence of one or more nitrogen oxides and a resulting increase in oxygen ion flux through the cell in proportion to a concentration of nitrogen oxides in the oxidizing atmosphere.

5. An electrochemical sensor comprising the electrochemical cell of claim 1.

6. The electrochemical sensor of claim 5, wherein the sensor is operable to exhibit at least sixty percent of its equilibrium response to the presence of nitrogen oxides in less than one minute, or more specifically in less than one second, or more specifically in less than 200 milliseconds.

7. An amperometric ceramic electrochemical cell, comprising:
an electrolyte layer comprising a continuous network of a first material which is ionically conducting at an operating temperature of about 200 to 550° C.;
a counter electrode layer comprising a continuous network of a second material which is electrically conductive at an operating temperature of about 200 to 550° C.; and
a sensing electrode layer comprising a continuous network of a third material which is electrically conductive at an operating temperature of about 200 to 550° C., which sensing electrode is operable to exhibit increased charge transfer in the presence of one or more target gas species.

8. The electrochemical cell of claim 7, wherein the electrolyte layer prevents physical contact between the counter electrode layer and the sensing electrode layer, and wherein the cell is operable to exhibit conductivity to oxygen ions at an operating temperature of about 200 to 550° C. and increased or decreased resistance in the presence of the one or more target gas species.

9. An electrochemical sensor comprising the electrochemical cell of claim 7, operable to generate an electrical signal as a function of target gas concentration in an oxygen-containing gas stream, in the absence of additional sensing electrodes or oxygen pumping currents.

10. The electrochemical cell of claim 1, wherein the electrode layers are symmetrically opposed to one another on each side of the electrolyte layer, whereby oxygen ion current flows through a thickness of the electrolyte.

11. The electrochemical cell of claim 1, wherein the electrode layers are laterally spaced on a single surface of the electrolyte layer, with an uncoated area of the surface of the electrolyte layer between the electrode layers.

12. The electrochemical cell of claim 11, wherein the electrode layers are interspaced to form an interdigitated or interlocking design of electrodes of opposite polarity while maintaining a minimal electrode path length therebetween.

13. The electrochemical cell of claim 1, wherein the electrolyte layer has a hollow tubular configuration, and the electrode layers are applied internally and/or externally to the electrolyte layer.

14. The electrochemical cell of claim 1, the electrolyte layer comprises a porous component and prevents physical contact between the electrode layers.

15. The electrochemical sensor of claim 5, further comprising a substrate for the electrochemical cell, the substrate comprising insulating ceramic or a metal or cermet material coated with an insulator.

16. The electrochemical sensor of claim 15, further comprising an electrical heating element applied to or embedded in the substrate, electrically isolated from the electrode layers and the electrolyte layer of the electrochemical cell.

17. The electrochemical sensor of claim 5, further comprising a protective layer of a porous material.

18. An electrochemical cell for the amperometric detection of one or more gas species, comprising
an ionically conducting electrolyte membrane,
a sensing electrode comprising an electrically conducting ceramic,
and a counter electrode comprising an electrically conducting ceramic, cermet or metal,
wherein the electrochemical cell is operable to pass current by reduction of oxygen at the sensing electrode, transport of oxygen ions through the electrolyte, and recombination of oxygen ions at the counter electrode layer.

19. The electrochemical cell of claim 18, wherein the sensing electrode is operable to exhibit varying catalysis of oxygen reduction in the presence of NO_{X}, NH₃, CO, CO₂, and/or SO_{X}.

20. The electrochemical cell of claim 18, wherein the sensing electrode is operable to exhibit reversible adsorption of NO and NO₂ and varying catalysis of oxygen reduction in the presence of NO_{X}, NH₃, CO, CO₂, and/or SO_{X}.

21. The electrochemical cell of claim 18, wherein the sensing electrode includes a catalytic or electrocatalytic promoter.

22. The electrochemical cell of claim 21, wherein the catalytic or electrocatalytic promoter comprises cerium or doped cerium oxide.

23. The electrochemical cell of claim 18, wherein the sensing electrode includes a catalytic or electrocatalytic promoter to enhance a capacity or rate of adsorption of NO, NO₂, and/or NH₃.

24. The electrochemical cell of claim 23, wherein the catalytic or electrocatalytic promoter comprises a material that oxidizes NO to NO₂.

25. The electrochemical cell of claim 23, wherein the catalytic or electrocatalytic promoter comprises an alkali metal or an alkaline earth metal.

26. The electrochemical cell of claim 23, wherein the catalytic or electrocatalytic promoter comprises one or more of K, Na, Li, Mg, Ca, Sr, Ba, Co, Pt and Fe.

27. The electrochemical cell of claim 18, wherein the sensing electrode includes an inhibitor which decreases electrical resistance of the cell in the absence of NO_{X}.

28. The electrochemical cell of claim 27, wherein the inhibitor comprises one or more of Cl, F, K, Ba, Na, Ca, La, Sr, Mg and Li.

29. The electrochemical cell of claim 18, wherein the sensing electrode includes a catalytic or electrocatalytic promoter to catalyze the oxidation of residual hydrocarbons, CO, NH₃, elemental carbon, or other reductants in the gas stream, improving signal selectivity in the presence of NO and NO₂.

30. The electrochemical cell of claim 29, wherein the catalytic or electrocatalytic promoter comprises one or more of Ag, Au, Pt, Pd, Ru, Ir, Ni, Fe, Cu, Sn, V, Rh, Co, W, Mo, U, Zn, Mn, Cr and Nb.

31. The electrochemical cell of claim 18, wherein the sensing electrode includes a catalytic or electrocatalytic promoter to enhance selectivity to SO_{X}, NH₃, or other gaseous species.

32. An electrochemical cell for the amperometric detection of gas species, comprising
an ionically conducting electrolyte comprising
cerium oxide doped with Ca, Sr, Sc, Y, Pr, Nd, Pm, Sm, Eu, Gd, Tb, Dy, Ho, Er, Tm, Yb, La, or a mixture thereof;
zirconium oxide doped with Ca, Mg, Sc, Y, Ce, or a mixture thereof;
bismuth oxide doped with Y, V, Cu, Er or a mixture thereof; or
lanthanum gallium oxide doped with Sr, Mg, Zn, Co, Fe or a mixture thereof;
a sensing electrode comprising
lanthanide manganite perovskite material, doped with Ca, Sr, Ba, Fe, Co, Ni, Cu, Zn, Mg or a mixture thereof;
lanthanide ferrite perovskite material, doped with Ca, Sr, Ba, Mn, Co, Ni, Cu, Zn, Mg or a mixture thereof;
lanthanide cobaltite perovskite material, doped with Ca, Sr, Ba, Mn, Fe, Ni, Cu, Zn, Mg or a mixture thereof;
lanthanide nickelate perovskite material, doped with Ca, Sr, Ba, Mn, Fe, Co, Cu, Zn, Mg or a mixture thereof; or
lanthanide cuprate perovskite material, doped with Ca, Sr, Ba, Mn, Fe, Co, Ni, or a mixture thereof; and
a counter electrode comprising
lanthanide manganite perovskite material, doped with Ca, Sr, Ba, Fe, Co, Ni, Cu, Zn, Mg or a mixture thereof;
lanthanide ferrite perovskite material, doped with Ca, Sr, Ba, Mn, Co, Ni, Cu, Zn, Mg or a mixture thereof;
lanthanide cobaltite perovskite material, doped with Ca, Sr, Ba, Mn, Fe, Ni, Cu, Zn, Mg or a mixture thereof;
lanthanide nickelate perovskite material, doped with Ca, Sr, Ba, Mn, Fe, Co, Cu, Zn, Mg or a mixture thereof;
lanthanide cuprate perovskite material, doped with Ca, Sr, Ba, Mn, Fe, Co, Ni, or a mixture thereof; or
a metal material comprising Ni, Fe, Cu, Ag, Au, Pd, Pt, or Ir, or an alloy or a cermet thereof.

33. The electrochemical cell of claim 32, wherein
the electrolyte comprises ionically conducting cerium oxide doped with Ca, Sr, Sc, Y, Pr, Nd, Pm, Sm, Eu, Gd, Tb, Dy, Ho, Er, Tm, Yb, La or a mixture thereof;
the sensing electrode material comprises lanthanide ferrite perovskite material doped with Ca, Sr, Ba, Mn, Co, Ni, Cu, Zn, Mg or a mixture thereof, or lanthanide cobaltite perovskite material doped with Ca, Sr, Ba, Mn, Fe, Ni, Cu, Zn, Mg or a mixture thereof; and
the counter electrode material comprises lanthanide ferrite perovskite material doped with Ca, Sr, Ba, Mn, Co, Ni, Cu, Zn, Mg or a mixture thereof, lanthanide cobaltite perovskite material doped with Ca, Sr, Ba, Mn, Fe, Ni, Cu, Zn, Mg or a mixture thereof, or a metal material comprising Ni, Fe, Cu, Ag, Au, Pd, Pt, or Ir, or an alloy or cermet thereof.

34. The electrochemical cell of claim 33, wherein the electrolyte is ionically conducting and comprises cerium oxide doped with Y, Nd, Sm, Gd, La or mixtures thereof; the sensing electrode is ionically and electronically conducting and comprises Sr and Co doped lanthanide ferrite, and the counter electrode is electronically conducting.

35. The electrochemical cell of claim 33, wherein the electrolyte is ionically conducting and comprises Sm-doped cerium oxide electrolyte; the sensing electrode is ionically and electronically conducting and comprises Lanthanum Strontium Cobalt Ferrite, and the counter electrode is an electrically conducting and comprises Lanthanum Strontium Cobalt Ferrite.

36. An amperometric ceramic electrochemical cell, comprising an electrolyte layer, a sensing electrode layer, and a counter electrode layer, wherein the cell is operable in an oxidizing atmosphere and under a first applied bias to exhibit enhanced reduction of oxygen molecules at the sensing electrode in the presence of one or more nitrogen oxides (NO_{X}) and a resulting increase in oxygen ion flux through the cell and is operable in the oxidizing atmosphere and under a second applied bias different from the first applied bias to exhibit enhanced reduction of oxygen molecules at the sensing electrode in the presence of NH₃ and a resulting increase in oxygen ion flux through the cell.

37. An amperometric ceramic electrochemical cell, comprising an electrolyte layer, a first electrode layer, and a second electrode layer, wherein the cell is operable in an oxidizing atmosphere and under a first applied bias to exhibit enhanced reduction of oxygen molecules at the first electrode in the presence of one or more nitrogen oxides (NO_{X}) and a resulting increase in oxygen ion flux through the cell and is operable in the oxidizing atmosphere and under a second applied bias different from the first applied bias to exhibit enhanced reduction of oxygen molecules at the second electrode in the presence of NH₃ and a resulting increase in oxygen ion flux through the cell.

38. An amperometric electrochemical sensor, comprising
a first amperometric ceramic electrochemical cell comprising an electrolyte layer, a sensing electrode layer, and a counter electrode layer, wherein the cell is operable in an oxidizing atmosphere and under a first applied bias to exhibit enhanced reduction of oxygen molecules at the sensing electrode in the presence of one or more nitrogen oxides (NO_{X}) and a resulting increase in oxygen ion flux through the cell and is operable in the oxidizing atmosphere; and
a second amperometric ceramic electrochemical cell comprising an electrolyte layer, a sensing electrode layer, and a counter electrode layer, wherein the cell is operable under a second applied bias different from the first applied bias to exhibit enhanced reduction of oxygen molecules at the sensing electrode in the presence of NH₃ and a resulting increase in oxygen ion flux through the cell.

39. The electrochemical sensor of claim 38, further comprising a substrate for the electrochemical cells, the substrate comprising insulating ceramic or a metal or cermet material coated with an insulator.

40. The electrochemical cell of claim 2, wherein the cell is operable to exhibit the enhanced reduction of oxygen molecules at the sensing electrode in the presence of one or more nitrogen oxides and a resulting increase in oxygen ion flux through the cell in proportion to a concentration of nitrogen oxides in the oxidizing atmosphere.

41. The electrochemical cell of claim 39, wherein the electrolyte layer is ionically conducting and comprises cerium oxide doped with Y, Nd, Sm, Gd, La or mixtures thereof; the sensing electrode layer is ionically and electronically conducting and comprises Sr and Co doped lanthanide ferrite, and the counter electrode layer is electronically conducting and comprises Sr and Co doped lanthanide ferrite.

42. The electrochemical cell of claim 41, wherein the electrolyte layer comprises Gadolinium-doped ceria (GDC) or Samarium-doped ceria (SDC).

43. An electrochemical sensor comprising the electrochemical cell of claim 41 fabricated on a yttrium-doped zirconia, aluminum oxide (Al₂O₃), magnesium oxide (MgO), or magnesium aluminate (MgAl₂O₄) substrate.

44. The electrochemical sensor of claim 43, further comprising an electrical heating element applied to or embedded in the substrate, electrically isolated from the electrode layers and the electrolyte layer.

45. The electrochemical cell of claim 43, wherein the sensing electrode includes a catalytic or electrocatalytic promoter.
